(19) United States
(12) Patent Application Publication
(10) Pub. No.: US 2015/0240038 A1
(43) Pub. Date: Aug. 27, 2015

(54) METHOD AND APPARATUS FOR TRANSFERRING GRAPHENE TO A POLYMERIC SUBSTRATE

(71) Applicants: NATIONAL UNIVERSITY OF SINGAPORE, Singapore (SG); PRESBYTERIAN MACKENZIE UNIVERSITY, Sao Paulo (BR)

(72) Inventors: Guilhermino Jose MACEDO FECHINE, Sao Paulo (BR); Barbaros OZYILMAZ, Singapore (SG); Antonio Helio CASTRO NETO, Singapore (SG); Inigo MARTIN FERNANDEZ, Singapore (SG)

(21) Appl. No.: 14/631,942

(22) Filed: Feb. 26, 2015

Related U.S. Application Data
(60) Provisional application No. 61/944,810, filed on Feb. 26, 2014.

(51) Int. Cl. C08J 5/12; B32B 37/15; B32B 37/10; B32B 9/04; B32B 37/00; B32B 38/10; B32B 38/16; B32B 9/00; C01B 31/04; B32B 37/06

(52) U.S. Cl. CPC C08J 5/121; C01B 31/0484; B32B 37/15; B32B 37/1027; B32B 37/06; B32B 37/0046; B32B 37/025; B32B 38/10; B32B 38/162; B32B 9/007; B32B 9/045; C08J 2300/00; B32B 2313/04; B32B 2457/12; B32B 2457/00; B32B 2535/00

(57) ABSTRACT

A method of transferring graphene to a polymeric substrate is disclosed herein. In a described embodiment, the method 400 comprises heating the polymeric substrate at 408 to at least partially melt the polymeric substrate; compressing the at least partially melted polymeric substrate against the graphene at 410 to form an intermediate graphene composite; and cooling the intermediate graphene composite at 412 to transfer the graphene to the polymeric substrate. Apparatuses for performing the transfer are also disclosed.

### CROSS-REFERENCE TO RELATED APPLICATIONS

The present application claims priority to U.S. Provisional Patent Application No. 61/944,810, filed Feb. 26, 2014, titled “TRANSFER OF GRAPHENE TO POLYMERIC SUBSTRATES USING POLYMER PROCESSING TECHNIQUES,” which is incorporated herein by reference in its entirety.

### BACKGROUND AND FIELD

The invention relates to a method and apparatus for transferring graphene to a polymeric substrate.

There are known methods to produce graphene with different dimensions and purity. For example, mechanical exfoliation of graphite, chemical exfoliations, synthesis on Si/SiO₂ and chemical vapour deposition (CVD) are the most used procedures to obtain graphene. Depending on applications, it is needed to transfer graphene from its growth substrate (such as a metal foil) to a target substrate such as a polymeric film.

To achieve such a transfer, a common graphene transfer technique includes several steps. Firstly, the graphene-metal foil composite is covered with a polymer film using spin coating with the polymer film functioning as a supporting layer. A common polymer film is poly (methyl methacrylate) (PMMA). Secondly, the metal foil is etched to separate the graphene from the graphene-metal foil composite and what remains is a graphene-polymer film composite. If the metal foil is copper, a solution of ammonium persulfate is used for the etching, which may take about six hours and at the end, the graphene-polymer film composite is rinsed exceedingly in deionised water to remove any contaminate.

With the graphene-polymer film composite staying floated on the deionised water, the composite is transferred directly to a final substrate by scooping. However, adhesion between the graphene of the graphene-polymer film composite and the final substrate is weak and the polymer film has to be removed. As a result, an annealing process is performed to increase the adhesion between the graphene and the final substrate, and a solvent is used to remove the polymer film. Unfortunately, contaminations (metal and polymer), cracks and wrinkles on the graphene using this procedure could occur. Further, size of the graphene transferred is also limited.

Other transfer techniques have also been introduced. For example, in a “roll-to-roll” transfer technique, a thermal release tape (TRT) is used as a supporting layer to transfer large-area graphene to a polymeric substrate. Similar to the above, the graphene is grown on a metal foil as a growth substrate to form a first composite. The first composite and the TRT are next passed between two rollers with enough pressure for the graphene of the first composite to be attached to the TRT. Subsequently, the metal foil is removed by etching to leave a second composite comprising the graphene and the TRT. Finally, the graphene is transferred to a target substrate by using the two rollers again and at the right temperature to detach the TRT and release the graphene to the target substrate. This technique can transfer large-area graphene but bonding between the graphene and the target substrate is still relatively weak.

In another known example, a stamp method may be used to transfer graphene to a target substrate. Briefly, the stamp method includes picking up graphene with an elastomeric material (for example, polydimethylsiloxane (PDMS)) and stamping the graphene onto the target substrate. However, this method is useful only if the adhesion energy between graphene and the target substrate is stronger than that between the graphene and the stamp and only for flat and hydrophilic substrates. Further, the stamping may introduce mechanical stress that could induce cracks, thus weakening the bond between the graphene and the target substrate.

It is an object of the present invention to provide a method and apparatus for transferring graphene to a polymeric substrate which addresses at least one of the disadvantages of the prior art and/or to provide the public with a useful choice.

### SUMMARY

In a first aspect, there is provided a method of transferring graphene to a polymeric substrate, the method comprising:
(i) heating the polymeric substrate to at least partially melt the polymeric substrate;
(ii) compressing the at least partially melted polymeric substrate against the graphene to form an intermediate graphene composite; and
(iii) cooling the intermediate graphene composite to bond the graphene to the polymeric substrate.

The term “graphene” is used in a general sense to mean various forms of graphene or graphite composition such as graphene monolayer, graphene bilayer, graphene multilayer, graphene foam, graphene oxide, graphene nanoribbons, graphite, graphite oxide, carbon nanotubes and fullerene etc.

Similarly, the term “polymeric” or “polymer” is used in a general sense to mean various forms of polymers such as homopolymers, copolymers, polymer blends, polymer composites and melted processable elastomers etc.

An advantage of the described embodiment is that high binding energy/strength between the graphene and the polymeric substrate may be achieved. Further, it is possible to achieve a final product with 2D or 3D polymer-graphene structures without etching the graphene substrate.

In some exemplary embodiments, the method may further comprise providing the graphene on at least one of an upper compression member and a lower compression member of a compression machine. The upper compression member may include protruding mold members arranged to cooperate with mold grooves of the lower compression member. Advantageously, the method may further comprise applying a pre-compression pressure to enable the graphene to maintain contact with the polymeric substrate for a predetermined time period, and after the predetermined time period, compressing the at least partially melted polymeric substrate against the graphene may include applying a compression pressure, which is greater than the pre-compression pressure, to the at least partially melted polymeric substrate and the graphene. Preferably, applying the pre-compression pressure and the heating may be performed simultaneously.

The cooling feature (iii) may include cooling the intermediate graphene composite at a cooling rate of about 50° C./min until a temperature of about 25° C.

The method may also comprise, prior to (i), growing the graphene directly on the at least one of the upper compression member and the lower compression member. In the alternative, the graphene may be grown on a growth substrate, and the method may then include, prior to (i), providing the graphene and the growth substrate on the at least one of the upper compression member and the lower compression member. In such a case, the method may further comprise, after (iii), removing the growth substrate by peeling or electrochemical delamination.

In other exemplary embodiments, the heating feature (i) may further include shearing the polymer substrate to produce the at least partially melted polymeric substrate.

In a specific exemplary embodiment, the shearing may be performed by an extruder screw. In this case, the method may further comprise forcing the at least partially melted polymeric substrate through a die prior to (ii). Preferably, the compression feature (ii) may include pressure rolling the at least partially melted polymeric substrate and the graphene through a first set of rollers; and simultaneously heating the at least partially melted polymeric substrate and the graphene to form the intermediate graphene composite. Advantageously, the cooling feature (iii) may include, after the first set of rollers, pressure rolling the intermediate graphene composite through a second set of rollers, and simultaneously cooling the intermediate graphene composite to transfer the graphene to the polymeric substrate. It is possible that the graphene may be grown on a growth substrate, and the method may then further comprise, after (iii), removing the growth substrate by peeling or electrochemical delamination.

In another specific exemplary embodiment, the shearing may be performed by a plunger. In such a case, the compression feature (ii) may further comprise injecting the at least partially melted polymeric substrate into an injection mold. The method may also comprise, prior to (i), forming graphene on an inner surface of the injection mold. Further, the cooling step may further comprise, opening the mold; and ejecting the transferred graphene and polymeric substrate out of the mold. It is possible that the graphene may be grown on a growth substrate, and the method may further comprise, after (iii), removing the growth substrate by peeling or electrochemical delamination. The method may further comprise enabling controlling the coverage of the graphene upon peeling by controlling the rheological characteristics of the polymeric substrate.

It should be appreciated that actual values of the various parameters such as compression pressure, heating temperature and cooling rate are dependent on the rheological properties of the polymeric substrate used. In exemplary embodiments, the heating feature (i) may include heating to a transfer temperature which is at least 10° C. above the polymeric substrate's melting temperature. Typically the transfer temperature may be about 20° C. above the polymeric substrate's melting temperature.

The method may also comprise, prior to (i), cleaning and drying the graphene and the polymeric substrate. With the polymeric processing techniques described the exemplary embodiments, the bonded or transferred graphene and polymeric substrate may have a 2-dimensional or 3-dimensional structure.

Indeed, the embodiments also relate to a device substrate comprising graphene transferred to a polymeric substrate obtained by the method as discussed above, and which forms a second aspect.

In a third aspect, there is provided apparatus for transferring graphene to a polymeric substrate, the apparatus comprising:
(i) a heater for heating the polymeric substrate to at least partially melt the polymeric substrate;
(ii) a pressure device for compressing the at least partially melted polymeric substrate against the graphene to form an intermediate graphene composite; and
(iii) a cooling device for cooling the intermediate graphene composite to bond the graphene to the polymeric substrate.

In some exemplary embodiments, the pressure device may include an upper compression plate and a lower compression plate opposing the upper compression plate and movable relative to each other, and wherein the graphene is provided on at least one of the upper and lower compression plates. The upper compression member may include protruding mold members arranged to cooperate with mold grooves of the lower compression member.

Preferably, the upper and lower compression members may be arranged to apply a pre-compression pressure to enable the graphene to maintain contact with the polymeric substrate for a predetermined time period; and, after the predetermined time period, the upper and the lower compression members may be further arranged to apply a compression pressure to the at least partially melted polymeric substrate and the graphene, the compression pressure being greater than the pre-compression pressure.

In a specific exemplary embodiment, the apparatus may further comprise an extruder screw for shearing the polymer substrate to produce the at least partially melted polymeric substrate. The apparatus may further comprise a die, wherein the extruder screw is arranged to force the at least partially melted polymeric substrate through the die. The pressure device may further comprise a first set of rollers downstream of the die, the first set of rollers arranged to pressure roll the at least partially melted polymeric substrate and the graphene, and a roller heater for simultaneously heating the at least partially melted polymeric substrate and the graphene to form the intermediate graphene composite. The cooling device may be coupled to a second set of rollers downstream of the first set of rollers, with the second set of rollers arranged to pressure roll the intermediate graphene composite, and the cooling device may be arranged to simultaneously cool the intermediate graphene composite to transfer the graphene to and the polymeric substrate.

In another specific exemplary embodiment, the apparatus may further comprise a plunger for shearing the polymer substrate to produce the at least partially melted polymeric substrate. The apparatus may further comprise an injection mold, wherein the plunger is arranged to inject the at least partially polymeric substrate into the injection mold. Preferably, the injection mold may include extractors for ejecting the transferred graphene and the polymeric substrate out of the injection mold. Advantageously, the cooling device may be coupled to the injection mold and arranged to cool the intermediate graphene composite to transfer the graphene to the polymeric substrate.

In a fourth aspect, there is provided a method of transferring graphene to a polymer substrate, the method comprising:
i) cleaning and drying the graphene and polymeric substrate,
ii) positioning the graphene and the polymeric substrate into desired structure,
iii) adjusting temperature of plates,
iv) positioning the desired structure between the plates and
v) applying pressure to the desired structure via the plates, thereby allowing the polymeric structure to become fluid or melted to allow the graphene to be transferred onto the substrate.

It should be appreciated that features relevant to one aspect may also be relevant to the other aspects.

### BRIEF DESCRIPTION OF THE DRAWINGS

Exemplary embodiments will now be described with reference to the accompanying drawings, in which:

FIG. 1 is a simplified diagram of an apparatus including a compression machine for bonding graphene and a polymeric substrate according to a first embodiment,

FIG. 2 is a front view of a top graphene composite comprising graphene grown on a copper growth substrate;

FIG. 3 is a front view of a polymeric substrate for bonding with the top graphene composite of FIG. 2;

FIG. 4 is a flowchart for bonding the graphene of FIG. 2 to the polymeric substrate of FIG. 3;

FIG. 5 shows the top graphene composite of FIG. 2 being stacked on top of the polymeric substrate of FIG. 3 to form a first embodiment graphene composite;

FIG. 6 shows the compression machine of FIG. 1 with the first embodiment graphene composite between upper and lower plates of the compression machine;

FIG. 7 shows the compression machine of FIG. 6 with a movable arm actuated to assert a download force to the upper plate of the compression machine;

FIG. 8 is a front view of a fused graphene composite produced by the compression machine of FIG. 7;

FIG. 9 is a front view of a 2D final graphene-polymer product after removing the copper growth substrate of the fused graphene composite of FIG. 8;

FIG. 10 shows the compression machine of FIG. 1 being used to produce variations of the final 2D graphene-polymer product of FIG. 9;

FIG. 11 is a front view of a first variation composite which comprises the first embodiment graphene composite of FIG. 5 and a bottom graphene composite;

FIG. 12 is a front view of a 2D graphene-polymer-graphene product after removing copper growth substrates from the first variation composite of FIG. 11;

FIG. 13 is a simplified diagram of a 3D compression machine having a mold comprising upper and lower mold halves according to a second embodiment;

FIG. 14 is a close-up view of the mold of the 3D compression machine of FIG. 13 showing graphene being grown on the upper and lower mold halves;

FIG. 15 shows the 3D compression machine of FIG. 14 and a second embodiment polymeric substrate between the upper and lower mold halves;

FIG. 16 shows the 3D compression machine of FIG. 15 but with the upper mold half caused to assert a downward force to produce a fused graphene composite;

FIG. 17 shows a final 3D graphene-polymer-graphene product after peeling the fused graphene composite of FIG. 16 from the 3D compression machine;

FIGS. 18 and 19 show other final 3D products which may be produced by the 3D compression machine of FIG. 13;

FIG. 20 illustrates how graphene grown on metal foils may be provided to the mold of FIG. 14 as a variation of the second embodiment;

FIGS. 21, 22(a) to (c) and 23(a) to (c) illustrate how various 3D final products may be formed from the variation of FIG. 20;

FIG. 24 is an apparatus for bonding graphene to a polymeric substrate according to a fourth embodiment which includes an extruder machine having a first stage and a second stage;

FIG. 25 is a closed-up view of portion CC of FIG. 24 to show a start of the second stage in more detail;

FIG. 26 shows the second stage of FIG. 25 but for producing a final graphene-polymer-graphene product;

FIG. 27 is an apparatus for bonding graphene to a polymeric substrate according to a fifth embodiment which includes an injection machine having a first stage and a second stage having an injection mold;

FIG. 28 is an enlarged view of a first injection mold half and a second injection mold half of the injection mold of FIG. 27;

FIG. 29 shows the first and second injection mold halves of FIG. 28 with graphene grown on inner surfaces of the mold halves;

FIG. 30 shows the injection mold of FIG. 29 being used to form a fourth embodiment fused graphene composite; and

FIG. 31 illustrates how the fourth embodiment fused graphene composite of FIG. 30 is ejected out of the injection mold.

### DETAILED DESCRIPTION OF PREFERRED EMBODIMENTS

FIG. 1 is a simplified diagram of an apparatus including a compression machine 100 for transferring graphene 150 to a polymeric substrate 160. The compression machine 100 includes an upper compression member and a lower compression member and in this embodiment, these include an upper plate 102 and a lower plate 104 arranged facing the upper plate 102. The compression machine 100 further includes an upper heating and cooling device 106 connected to the upper plate 102 and a lower heating and cooling device 108 connected to the lower plate 104. The compression machine 100 further includes a support table 110 for supporting the lower heating and cooling device 108 and the lower plate 104. The compression machine 100 also includes a pressure producing movable arm 112 attached to the upper heating and cooling device 106 and moving the movable arm 112 moves the upper plate 102 (and the upper heating and cooling device 106) vertically with respect to the lower plate 104 (and the lower heating and cooling device 108).

It should be appreciated that in this embodiment, the upper plate 102 is movable relative to the lower plate 104 but a reverse arrangement is also possible with the lower plate 104 movable and pressure is applied from the lower plate 104, instead of the upper plate 102. It is also possible that both the upper and lower plates 102,104 are movable with corresponding movable arms.

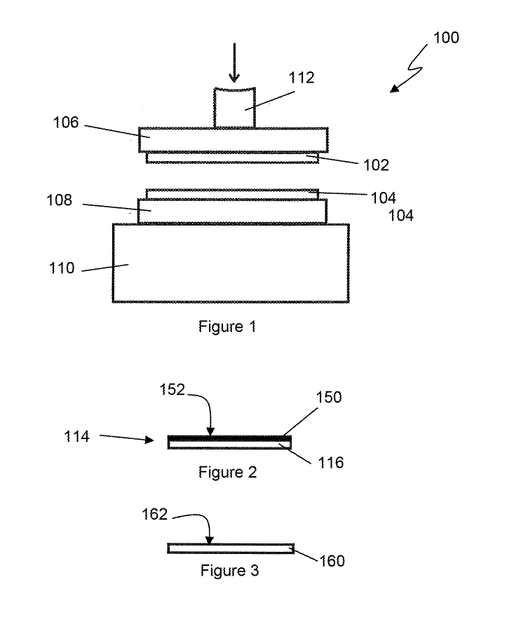

FIG. 2 is a top graphene composite 114 comprising the graphene 150 grown on a growth substrate in the form of a copper growth substrate 116. Needless to say, other types of metal may be used. In this embodiment, the graphene 150 is grown using CVD (although other methods of growing graphene may also be used). The copper growth substrate 116 is placed in a furnace and heated in low vacuum to around 1000° C. to increase its domain size. Methane and hydrogen gases are then owed through the furnace. The hydrogen is arranged to catalyze a reaction between methane and an exposed surface of the copper growth substrate, causing carbon atoms from the methane to be deposited onto the exposed surface of the copper growth substrate through chemical adsorption. The furnace is quickly cooled to keep the deposited carbon layer from aggregating into bulk graphite and causes the deposited carbon layer to crystallize into a contiguous layer of graphene 150 on the exposed surface of the copper growth substrate 116 to form the top graphene composite 114. It should be appreciated that quantity and distribution of the layer of graphene 150 is controlled by CVD parameters and in this embodiment, dimensions of the copper growth substrate 116 and the graphene 150 deposited on the copper growth substrate 116 are controlled taking into account the dimensions of the upper and lower plates 102,104 of the compression machine 100.

FIG. 3 shows a device substrate in the form of the polymeric substrate 160 having a layer of polymeric film of thickness with at least 50 μm, although other thickness may also be used. This polymeric substrate 160 may be prepared by the compression machine 100 or bought off the shelf, and in this embodiment, low density polyethylene (LDPE) is used as the polymeric film.

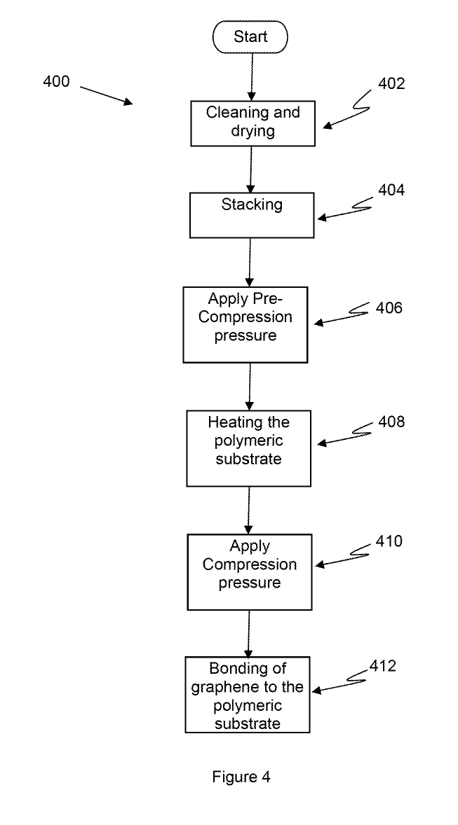

FIG. 4 is a general flowchart 400 illustrating a method for transferring graphene 150 to the polymeric substrate 160 according to the first embodiment. At step 402, the top graphene composite 114 and the polymeric substrate 160 are cleaned and dried to remove any moisture on their surfaces. Specifically, the top graphene composite 114 is subjected to 120° C. for about 10 minutes and a nitrogen flow to reduce or eliminate water molecules from its surface. The polymeric substrate 160 is washed with isopropyl alcohol (IPA) and also subjected to nitrogen flow to clean its surface.

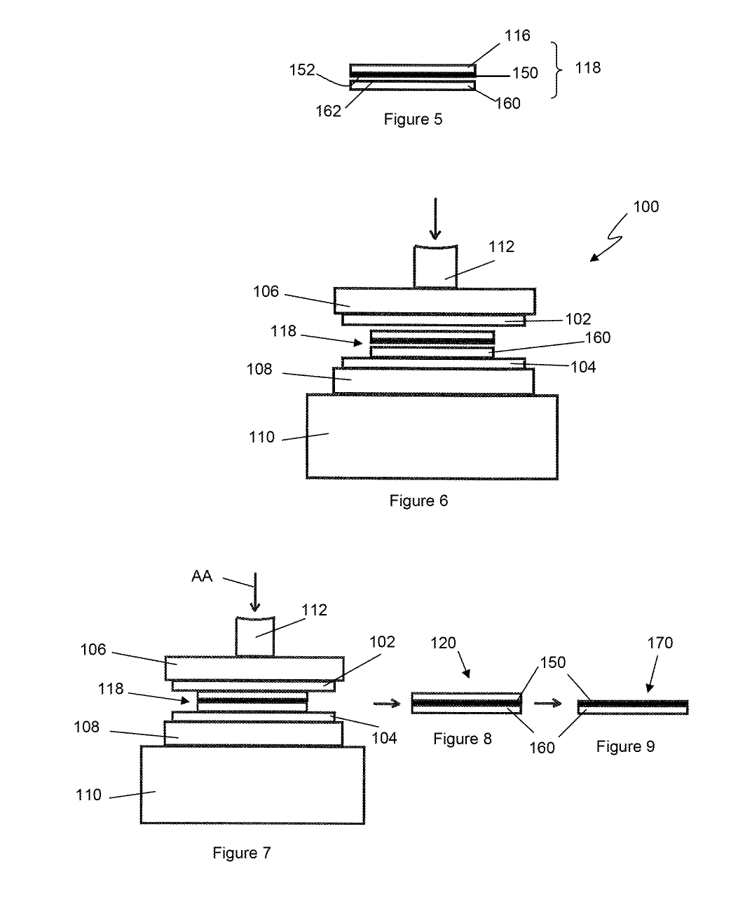

Next, at step 404, the top graphene composite 114 is stacked or placed on top of the polymeric substrate 160 with the graphene's bonding surface 152 in contact with a substrate first bonding surface 162 of the polymeric substrate 160 to form a first embodiment graphene composite 118 as shown in FIG. 5. In other words, the graphene 150 is sandwiched between the copper growth substrate 116 and the polymeric substrate 160.

The first embodiment graphene composite 118 is next transferred to the compression machine 100 and arranged between the upper and lower plates 102,104 with the polymeric substrate 160 resting on the lower plate 104 as shown in FIG. 6. In this arrangement, at step 406, the movable arm 112 is moved downwardly to apply a pre-compression pressure to achieve a good contact between the graphene 150 and the polymeric substrate 160.

Next, the upper and lower heating and cooling devices 106,108 are turned on to heat the respective upper and lower plates 102,104 which in turn heats up the first embodiment graphene composite 118 at step 408, and in particular the polymeric substrate 160, to a transfer temperature. Amount of contact time to maintain the pressure between the upper and lower plates 102,104 and the first embodiment graphene composite 118 is to at least partially melt the polymeric substrate 160 such that the polymeric substrate 160 becomes fluid. The amount of contact time depends on rheological properties of the polymeric substrate 160 used.

Indeed, in the present embodiment which uses LDPE as a base material for the polymeric substrate 160, the transfer temperature is set at about 140° C., which is about 20° C. above the melting temperature of LDPE. At this transfer temperature, the pre-compression pressure is maintained until the polymeric substrate 160 is at least partially melted, having a complex viscosity of about 8.10³ Pa·s.

When the polymeric substrate 160 is at least partially melted, the movable arm 112 asserts a compression pressure at step 410 towards the lower plate 104 and in this case, of about 350 kPa downwardly (see arrow AA in FIG. 7). This downward pressure compresses the graphene 160 and the melted polymeric substrate 160 together and the melted polymeric substrate 160 stays in contact with the first embodiment graphene composite 118 for about five minutes. Thereafter, at step 412, the upper and lower cooling devices 106,108 are set to cooling modes to cool the first embodiment graphene composite 118 at a rate of 50° C./min until a temperature of 25° C. in order to bond the graphene 150 to the polymeric substrate 160 to produce a fused graphene composite 120, which is shown in FIG. 8. In other words, the graphene is at least fused into the polymeric substrate 160 and in this way, the graphene 150 is transferred to the polymeric substrate 160.

Unpredictably, the at least partially melted polymeric substrate 160 may interact very well with the graphene when the appropriate rheological parameters are used and as a result, high binding energy is achieved between the graphene 150 and the polymeric substrate 160. The copper growth substrate 116 may then be removed by peeling or by electrochemical delamination to produce a 2D final graphene-polymer product 170 (see FIG. 9) with excellent bonding properties and without etching.

Fine tuning of the graphene 150 to the polymeric substrate 160 interactions during the graphene transfer process is based on control of the interface of these materials i.e., interface between the graphene's bonding surface 152 and the substrate bonding surface 162 of the polymeric substrate. A fine control of the compression pressure and transfer temperature may be needed during the transfer process to enhance the binding energy of the graphene 150 to the polymeric substrate 160. Control of the compression pressure is advantageous to keep the interaction between the graphene 150 and polymeric substrate 160 after the transfer and also drive the molecular arrangement of the polymer chain at the interface between the graphene's bonding surface 152 and the substrate bonding surface 162. The rate of cooling is important to control polymer morphology of the polymeric substrate.

These three parameters, compression pressure, temperature and rate of cooling, are chosen to tune or adjust the adhesion force (or fusion force) between the graphene 150 and the polymeric substrate 160 and control of the area covered by the graphene 150 under the polymeric substrate 160 (i.e., the target substrate). In the case of using ferroelectric polymers these parameters may also be chosen for the polymer to arrange into molecule conformations that can be electrically polarized to generate an electrostatic field that may modify the doping level of the graphene. The rate of cooling and the compression pressure are controlled by a temperature-pressure control device (not shown) of the compression machine 100. It should be mentioned that if the cooling rate is too quick, depending on the type of polymeric substrate 160 used, the polymeric substrate 160 may become amorphous and this may have an adverse effect on the effectiveness of the transfer.

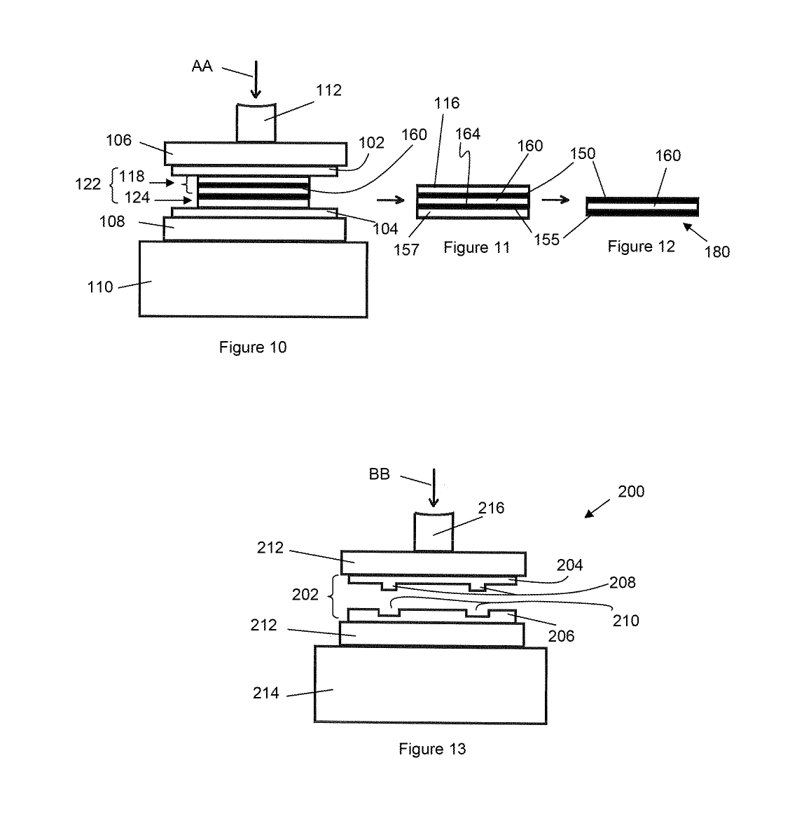

The compression machine 100 may be configured to produce other types of final products and a variation is shown in FIG. 10 which includes a first variation composite 122 comprising the first embodiment graphene composite 118 of FIG. 5 and with a bottom graphene composite 124 which includes a bottom graphene 155 grown on a bottom copper growth substrate 157 similar to the top graphene composite 114. The bottom graphene composite 124 is arranged below the polymeric substrate 160 of the first embodiment graphene composite 118 with the bottom graphene 155 in contact with a substrate second bonding surface 164 of the polymeric substrate 160. Similar process steps as described in steps 406 to 412 of FIG. 4 are performed for the graphene 150 and the bottom graphene 155 to be fused into the polymeric substrate 160 as shown in FIG. 11 and the copper growth substrate 116 and the bottom growth substrate 157 similarly removed by peeling or electrochemical delamination to produce a final graphene-polymer-graphene product 180 as shown in FIG. 12 with the polymeric substrate 160 sandwiched between and bonded to two layers of graphene 150,155.

FIG. 13 is a 3D compression machine 200 according to a second embodiment. The 3D compression machine 200 comprises an upper compression member and a lower compression member which cooperates to form a mold 202 in this embodiment. The mold 202 includes an upper mold half 204 and a lower mold half 206 arranged to cooperate with the upper mold half 204. The upper mold half 204 includes protruding mold members 208 arranged to be received in corresponding mold grooves 210 formed on the lower mold half 206.

The 3D compression machine 200 further includes a heating and cooling system 212 coupled to the upper and lower mold halves 204,206 similar to the first embodiment. The 3D compression machine 200 includes a mold support table 214 for supporting the mold 202 and the heating and cooling system 212 and also a movable pressure arm 216 for moving the upper mold half 204. Just like the first embodiment, in the alternative, pressure may be applied to the lower mold half 206 or to both mold halves 204,206.

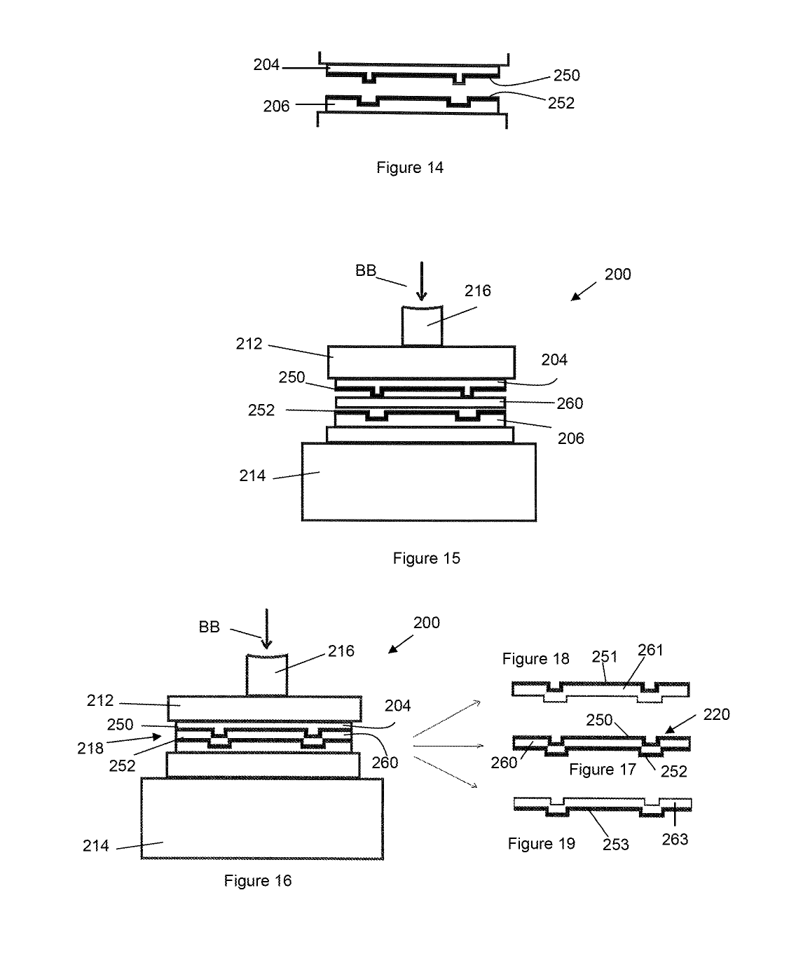

In the second embodiment, graphene 250,252 is grown directly on surfaces of the upper and lower mold 204,206 as shown in FIG. 14, which is a closed up view of the mold 202 of FIG. 13. It should be appreciated that dimension of the graphene 250,252 of this embodiment would be related to the dimension of the mold 202 of the 3D compression machine 200. Reference is also made to FIG. 4 as the general process for transferring the graphene 250,252 to a second embodiment polymeric substrate 260 (see FIG. 15).

Next, the second embodiment polymeric substrate 260, which also functions as a graphene support, is placed between the graphene 250,252 in the mold 202, as shown in FIG. 15, similar to step 402 of FIG. 4. The second embodiment polymeric substrate 260 is also made from LDPE, just like the first embodiment. It should be appreciated that the graphene 250,252 and the second embodiment polymeric substrate 260 may also be cleaned and dried in a similar manner as step 402 of FIG. 4 to avoid moisture on their surfaces prior to placing the second embodiment polymeric substrate 260 in the mold 202.

As shown in FIG. 15, the movable pressure arm 216 is next activated downwards as shown by arrow BB similar to step 406 of FIG. 4 to apply a second embodiment pre-compression pressure to provide a good contact between the graphene 250,252 and the polymeric substrate 260. The heating and cooling system 212 is also turned on, similar to step 408, to heat the mold halves 204,206 to a second embodiment transfer temperature of about 140° C. The second embodiment pre-compression pressure is maintained for about 5 minutes (or any other sufficient time) to melt (partially or fully melted until the polymeric substrate 260 is fluid) the polymeric substrate 260. Just like the first embodiment, amount of contact time depends on the rheological properties of the polymeric substrate used.

A second embodiment compression pressure of 350 kPa is applied to the mold 202, similar to step 410, by moving the movable pressure arm 216 further downwards to compress the graphene 250,252 and the (melted) polymeric substrate 260 together as shown in FIG. 16. This second embodiment compression pressure of 350 kPa is maintained for about two minutes to enable the graphene to be fused with the melted polymeric substrate 260 and thus, taking on a shape and configuration as defined by the protruding mold members 208 and the corresponding mold grooves 210. Next, the heating and cooling system 212 is turned to a cooling mode to cool the graphene 250,252 and the polymeric substrate 260 at a rate of 50° C./min until 25° C. to bond the graphene 250,252 to the polymeric substrate 260, as shown at step 412 of FIG. 4. In this way, a second embodiment fused graphene composite 218 is formed. In other words, the graphene 250,252 is at least fused into the polymeric substrate 260 and the graphene 250,252 is transferred to the polymeric substrate 260.

With the graphene 250,252 supported by and bonded to the polymeric substrate 260, the second embodiment fused graphene composite 218 is peeled off manually from the mold 202 to produce a 3D final graphene-polymer-graphene product 220 as shown in FIG. 17.

Advantageously, the 3D final graphene-polymer-graphene product 220 exhibits high binding energy between the graphene 250,252 and the polymeric substrate 160.

With the 3D compression machine 200, it is possible to produce other types of final 3D products for example, having a layer of graphene 251 on top of a polymeric substrate 261 as shown in FIG. 18, or a layer of graphene 253 below a polymeric substrate 263 as shown in FIG. 19. It should be appreciated that this means only a layer of graphene needs to be grown on either the upper or lower mold half 204,206.

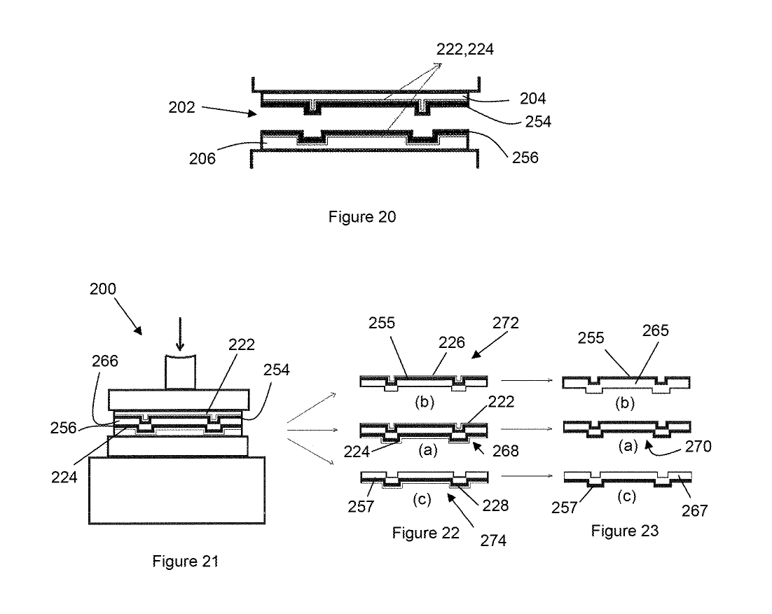

To illustrate the flexibility of the second embodiment, instead of growing the graphene 250,252 directly on the mold halves 204,206, it is possible to grow graphene 254,256 on a growth substrate and the growth substrate covering the surfaces of the upper and lower mold halves 204,206. This variation is shown in FIG. 20 which is a closed up view of the mold 202 of the 3D compression machine 200 of FIG. 13. The graphene 254,256 is first grown on respective metal foils 222,224 (as growth substrates) by CVD similar to the first embodiment, and the metal foils 222,224 are next laid onto exposed surfaces of the upper and lower mold halves 204,206. It should be appreciated that similar process steps of FIG. 4 are next performed to produce intermediate graphene composites 268 having the graphene 254,256 bonded to a polymeric substrate 266 as shown in FIG. 22(a) and eventually, the metal foils 222,224 are peeled off or delaminated electrochemically to produce a final 3D product 270 shown in FIG. 23(a) and which is similar to that shown in FIG. 17. Similarly, using this method and the 3D compression machine 200, other types of final 3D products may also be produced, for example, having a top layer of graphene 255 grown on a top metal foil 226 provided only on the upper mold half 204 to produce an intermediate composite 272 shown in FIG. 22(b) and with the top metal foil 226 removed to produce the final 3D product shown in FIG. 23(b) with the top layer of graphene 255 transferred to a polymeric substrate 265. Likewise, it is also possible to have a bottom layer of graphene 257 grown on a bottom metal foil 228 and which is laid onto the surface of the lower mold half 206 to produce an intermediate composite 274 of FIG. 22(c). Subsequently, the bottom metal foil 228 is removed to produce a final 3D product with the layer of graphene 257 below a polymeric substrate 267 as shown in FIG. 23(c) which is similar to that of FIG. 19.

Similar considerations as that described in relation to the first embodiment relating to the fine tuning of the graphene 250 to the polymeric substrate 260 interactions during the graphene transfer process etc needs to be taken into account and the compression pressure, the heating temperature and the rate of cooling are similarly important here.

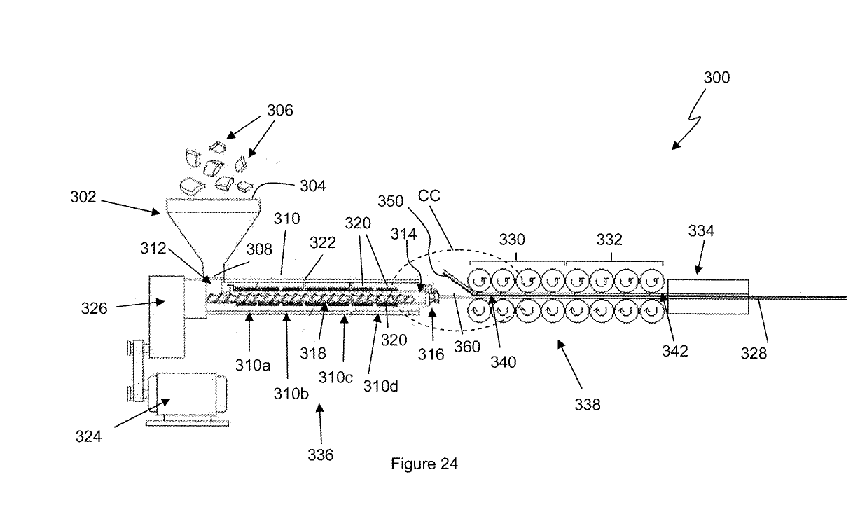

FIG. 24 is an extruder machine 300 which is an apparatus for transferring graphene to a polymeric substrate according to a third embodiment. The extruder machine 300 includes a hopper 302 having a top opening 304 for receiving pieces of polymer 306 and a hopper outlet 308 for discharging the pieces of polymer 306 and a barrel 310 having a barrel inlet 312 coupled to the hopper outlet 308 and a barrel outlet 314 coupled to a die 316. The barrel 314 is arranged to house an extruder screw 318 and the barrel 314 further includes a series of heaters 320 for heating the barrel 314. The heaters 320 are coupled to a thermocouple 322 to measure and control the temperature inside the barrel 314.

The series of heaters 320 are arranged to heat different sections or zones of the barrel 310 to varying temperatures. In this embodiment, the barrel 310 has four zones 310a,310b,310c,310d and the series of heaters 320 are arranged to heat these four zones 310a,310b,310c,310d to respective temperatures of about 110° C., 120° C., 130° C. and 140° C., with the temperature of the fourth zone 310d of 140° C. (nearest to the die 316) being a third embodiment transfer temperature.

The extruder machine 300 further includes a motor 324 arranged to power a gear reducer 326 which in turn is configured to rotate the extruder screw 318.

The die 316 is coupled to a conveyor 328 with a first set of opposing rollers 330 along the conveyor 328 and downstream of the die 316. The extruder machine 300 further comprises a second set of opposing rollers 332 arranged immediately after or downstream of the first set of opposing rollers 330 and the conveyor 328 is coupled to a post-processing station 334. The first set of opposing rollers 330 is connected to a roller heater (not shown) arranged to heat the first set of opposing rollers 330, while the second set of opposing rollers 332 is coupled to a roller cooling device (not shown) for cooling the second set of opposing rollers 332.

Broadly, the extruder machine 300 may be considered to have two stages—a first stage 336 comprising the motor 324 up to the die 316 is configured to melt the polymeric substrate 360 and a second stage 338 comprising the first set of opposing rollers 330 and the second set of opposing rollers 332 and associated roller heater and roller cooling devices are configured to perform a transfer process.

In use, the motor 324 is turned on to rotate the extruder screw 318 in a particular direction and at a speed of 30 rpm. In this embodiment, LDPE is used as a polymeric substrate 360 which explains why the third embodiment transfer temperature is set at 140° C. for the fourth zone 310d. Pieces of LDPE 306 are added into the hopper 302 and directed into the barrel 310 via the barrel inlet 312. With the combination of the heat at the third embodiment transfer temperature and the shearing due to the rotation of the extruder screw 318, the pieces of the LDPE 306 melts and is combined to form a continuous lump of polymer which is forced to pass through the die 316. The die 316 shapes the continuous lump of polymer into a thin layer of polymeric film (i.e., output of the first stage 336) and transfers the polymeric film to the second stage 338. It should be appreciated that dimension of the polymeric film is related to dimensions of the die 316.

Reference the flowchart 400 of FIG. 4, the above steps are similar to steps 406 and 408 which are to melt the polymeric substrate 360 and it should be apparent that the steps in FIG. 4 may not be in the exact sequence as depicted and the steps may be performed in any order to achieve the effect of transferring graphene to a polymeric substrate.

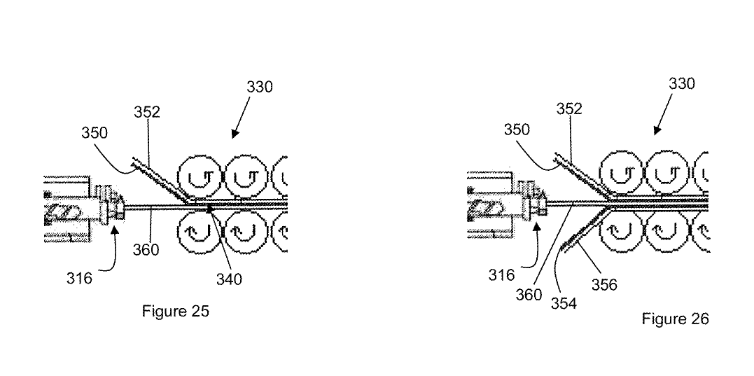

A layer of graphene 350 supported by metal foil 352 as graphene support is introduced at the start of the second stage 338 as shown in FIG. 25 which is a closed-up view of portion CC of FIG. 24 to show a start of the second stage 338 in more detail. The graphene 350 and the metal foil 352 may be cleaned and dried (similar to step 402 of FIG. 4) to remove any moisture on their surfaces and then introduced to the start of the conveyor 328 to be aligned with the layer of polymeric substrate 360 so that the graphene 350 (and the metal foil 352) is arranged on top of the polymeric substrate 360 (i.e., the stacking step of FIG. 4) to form a third embodiment graphene composite 340.

In the third embodiment graphene composite 340 is subject to pressure rolling by the first set of opposing rollers 330 at a third embodiment compression pressure (i.e., similar to step 410 of FIG. 4) of 350 kPa while, simultaneously, the first set of opposing roller 330 is heated to a temperature similar to the third embodiment transfer temperature in order to maintain the viscosity or fluidity of the melted polymeric substrate 360. Next, as the third embodiment graphene composite 340 leaves the first set of opposing rollers 330 and is subject to pressure rolling by the second set of opposing rollers 332, the third embodiment graphene composite 340 is cooled simultaneously at a cooling rate of 50° C./min by setting the roller cooling device to a cooling mode to bring down the temperature of the third embodiment graphene composite 332 to a temperature of 25° C. In this way, just like the first and second embodiments, the graphene 350 is fused into the polymeric substrate 360 to produce a third embodiment fused graphene composite 342, as illustrated in step 412 of FIG. 4.

The fused graphene composite 342 is next conveyed to the post-processing station 334 (see FIG. 24) during which the metal foil 352 is removed by peeling or electrochemical delamination to produce a final graphene-polymer product of a continuous length which possess high bonding strength. In this embodiment, the final product is 2D.

It should also be appreciated that the extruder machine 300 may also be adapted to produce a final graphene-polymer-graphene product by having a bottom layer of graphene 354 (supported by metal foil 356) introduced at the start of the first stage together with the (first) layer of graphene 350, as shown in FIG. 26.

As it can be appreciated, similar to the first and second embodiments, the third embodiment transfer temperature needs to be set high enough to make the polymeric substrate 360 fluid during the graphene transfer (i.e., second stage 338). Also, sufficient time needs to be provided for the first and second set of opposing rollers 330,332 to compress the graphene 350 and the polymeric substrate 360 for an effective transfer. The transfer time depends on the rheological properties of the polymeric substrate used and it may be adjusted by having an adequate number of rollers and pulling speed.

Fine tuning of the graphene 150 to the polymeric substrate 160 interactions during the graphene transfer process is based on control of the interface of these materials i.e., interface between the graphene 350 and the polymeric substrate 360. A fine control of the compression pressure and transfer temperature may be needed during the transfer process to enhance the binding energy of the graphene 350 to the polymeric substrate 360. Control of the compression pressure is advantageous to keep the interaction between the graphene 350 and polymeric substrate 360 after the transfer and also drive the molecular arrangement of the polymer chain at the interface between the graphene 350 and the polymeric substrate 360. The rate of cooling is important to control polymer morphology of the polymeric substrate.

These three parameters, compression pressure, heating temperature and rate of cooling, are chosen to tune or adjust the adhesion force (or fusion force) between the graphene 350 and the polymeric substrate 360 and control of the area covered by the graphene 350 under the polymeric substrate 360 (i.e., the target substrate). In the case of using ferroelectric polymers these parameters may also be chosen for the polymer to arrange into molecule conformations that can be electrically polarized to generate an electrostatic field that may modify the doping level of the graphene. The rate of cooling and the compression pressure are controlled in the second set of opposing rollers 332 by a temperature-pressure control device (not shown) of the extrude machine 300 and by the pulling speed.

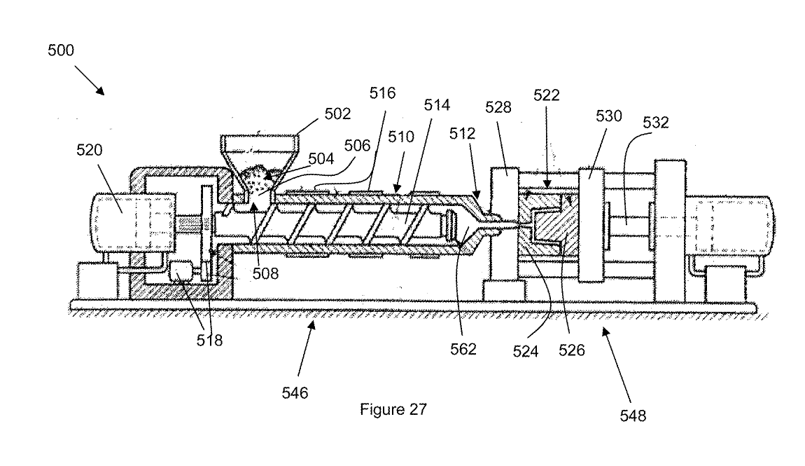

FIG. 27 is diagram of an injection machine 500 which is an apparatus for bonding graphene to a polymeric substrate according to a fourth embodiment. The injection machine 500 includes a polymer reservoir 502 for holding polymeric substrate and in this embodiment, the polymeric substrate is in the form of powdered LDPE 504 (although pellet LDPE is also suitable). The polymer reservoir 502 includes a reservoir outlet 506 for controlling discharge of the powdered LDPE 504 to a barrel opening 508 of an injection machine barrel 510.

The injection machine barrel 510 further includes a nozzle 512 for discharging contents of the injection machine barrel 510. The injection machine barrel 510 is arranged to house a screw-type reciprocating plunger 514 and the injection machine barrel 510 further includes a series of heaters 516 for heating the barrel 510. The series of heaters 516 is coupled to a temperature controller (not shown) to measure and control the temperature inside the barrel 510.

The injection machine 500 further includes a motor and gear assembly 518 and a cylinder 520 for screw-ram and this, together with the motor and gear assembly 518, is arranged to control the rotation and reciprocating action of the plunger 514.

The injection machine 500 further includes an injection mold 522 having a first injection mold half 524 and a second injection mold half 526. The first injection mold half 524 is coupled to a fixed housing 528 and the second injection mold half 526 is coupled to a movable platen 530 driven by a piston arm 532 to move linearly. As shown in FIG. 27, the nozzle 512 of the injection machine barrel 510 is arranged to inject its contents into the injection mold 522. Further, the injection machine 500 includes a heating and cooling system (not shown) for cooling the injection mold 522.

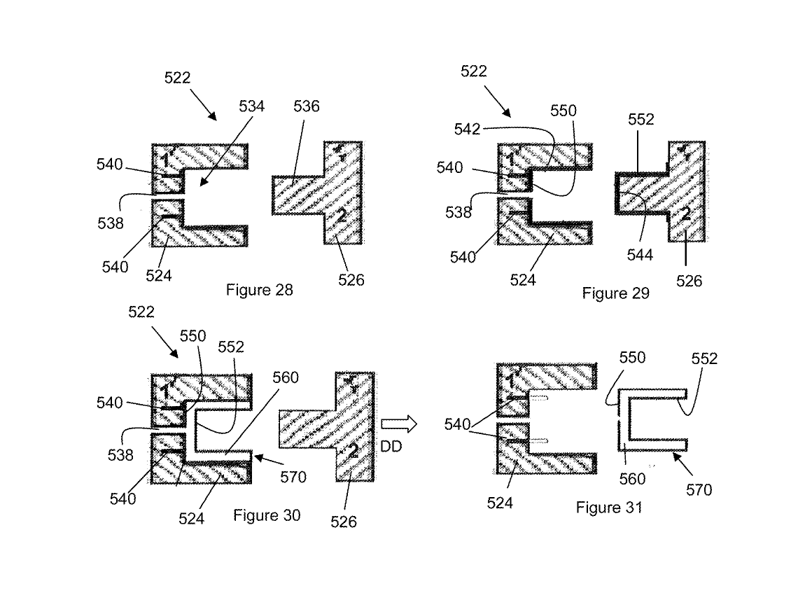

FIG. 28 is an enlarged view of the first injection mold half 524 and the second injection mold half 526 of injection mold 522 with both mold halves 524,526 separated. The injection mold 522 may be made from metals such as steel, aluminum, copper and metal alloys, and in this embodiment, the injection mold 522 is made of steel. The first injection mold half 524 has a generally C-shape cross section to define a mold cavity 534 arranged to receive a protruding block 536 of the second injection mold half 526. The first injection mold half 524 further includes an injection channel 538 in fluid communication with the nozzle 512 of the injection machine barrel 510. The first injection mold half 524 also includes two extractors 540 for ejecting a molded product out of the injection mold 522.

Broadly, the injection machine 500 may be considered to have two stages too—a first stage 546 comprising the motor and gear assembly 518 up to the plunger 514 which is configured to melt the polymeric substrate 560 and a second stage 548 comprising the injection mold 522 to perform a transfer process.

To begin the transfer process, graphene 550,552 is grown directly on inner surfaces 542,544 of the first and second injection mold halves 524,526 and this is shown in FIG. 29. It should be apparent that dimensions of the graphene 550,552 would be restricted by dimensions of the injection mold 522. As suggested in step 402 of FIG. 4, the graphene 550,552 should be cleaned and dried to avoid any moisture on its surfaces. The mold 522 is next closed by moving the movable platen 530 and leaving a suitable gap between the first injection mold half 524 and the second injection mold half 526 for the polymeric substrate 560 as shown in FIG. 27.

The powdered LDPE 504 is next channeled into the injection machine barrel 510 and the series of heaters 516 are turned on to heat the different zones of the injection machine barrel 510 up to a fourth embodiment transfer temperature of about 140° C. (again, about 20° C. above the melting temperature of LDPE) and the varying temperatures are similar to those discussed in the third embodiment (with the fourth embodiment transfer temperature being at a zone nearest to the nozzle 512. In other words, the temperature is ascending similar to the third embodiment). The plunger 514 is also activated to grind or shear the powdered LDPE 504 and this, together with the heat, transforms the powdered LDPE 504, into a viscous molten polymer 562 and the plunger 514 injects the molten polymer 562 into the mold 522 via the injection channel 538 at an injection speed of around 50 cm³/s.

It should be mentioned that the temperature of the injection machine barrel 510 and speed of rotation of the plunger 514 are selected according to rheological properties of the polymer (in this case, the LDPE). The speed of injecting the molten polymer into the injection mold 522 is also chosen according to rheological properties of the polymer.

The melted polymer is injected onto the injection mold 522 with a right quantity and at the injection speed. The temperature of the mold 522 needs to be set also to the fourth embodiment transfer temperature (by setting the heating and cooling system) to keep the molten polymer 562 in a melted state in the injection mold 522 for a sufficient time period for the graphene transfer to be effective. This is to allow the graphene 550,552 to be in contact with the molten polymer 562 for the time period to enhance the effectiveness of the transfer, with a compression pressure maintained by cooperation between first and second injection mold halves 524,526 (similar to step 410 of FIG. 4). In this embodiment, the time period is about 2 mins.

After the time period, the heating and cooling system is switched to a cooling mode to cool the graphene 550,552 and the molten polymer 562 at a cooling rate of 50° C./min to solidify the polymer so that a fourth embodiment fused graphene composite 570 (see FIG. 30, which is described in step 412 of FIG. 4) is formed in the injection mold 522. The movable plate 530 is activated to separate the second injection mold half 526 from the first injection mold half 524 by moving the second injection mold half 526 in a direction of arrow DD. Next, the extractors 540 are activated to eject the fused graphene composite 570 from the first injection mold half 524 to form a final 3D graphene-polymer-graphene product which has a generally C-shape cross-section.

With the injection machine of FIG. 27, it is again possible to achieve high binding energy between the graphene 550,552 and the polymeric substrate 560. For an effective transfer, it should be appreciated that the injection speed, temperature of the injection mold 522, molten polymer 562 contact time with the graphene 550,552 in the injection mold 522 and injection pressure are selected according to rheological properties of the polymeric substrate 560.

Indeed, binding energy between the graphene 550,552 and the polymeric substrate 560 higher than 720 mJ/m² is achievable, not just for this embodiment but also the other embodiments too.

Fine tuning of the graphene 550,552 to the polymeric substrate 560 interactions during the graphene transfer process is based on control of the interface of these materials i.e., interface between the graphene 550,552 and the polymeric substrate 560. A fine control of the compression pressure and transfer temperature may be needed during the transfer process to enhance the binding energy of the graphene 550,552 to the polymeric substrate 560. Control of the compression pressure is advantageous to keep the interaction between the graphene 550,552 and polymeric substrate 560 after the transfer and also drive the molecular arrangement of the polymer chain at the interface between the graphene 550,552 and the polymeric substrate 560. The rate of cooling is important to control polymer morphology of the polymeric substrate 560.

These three parameters, compression pressure, heating temperature and rate of cooling, are chosen to tune or adjust the adhesion force (or fusion force) between the graphene 550,552 and the polymeric substrate 560 and control of the area covered by the graphene 550,552 under the polymeric substrate 560 (i.e., the target substrate). For example, in the case of using ferroelectric polymers these parameters may also be chosen for the polymer to arrange into molecule conformations that can be electrically polarized to generate an electrostatic field that may modify the doping level of the graphene. The rate of cooling is are controlled by the heating and cooling system of the injection mold 522 and the compression pressure is controlled by the injection speed of the molten polymer 562 into the injection mold 522 and the hold pressure from the injection mold 522 (i.e., the first and second injection mold halves 524,526).

The methodology of graphene transfer to polymeric substrates described in these embodiments is based on melting of the polymeric substrates and its contact with graphene supported by a growth substrate (such as metal foil). This is based on realization that a good adhesion between graphene and the melted polymer is needed to have a good transfer. In these embodiments, good adhesion is obtained by the use of the control of the temperature and pressure in polymer processing equipment. Thus, a good understanding of the rheological characteristics of the polymer and polymer processing techniques is useful to have an effective graphene transfer.

The polymeric substrate needs to be at least partially melted or completely melted to create a viscous polymeric substrate by controlling of pressure and heating using polymer processing techniques. These embodiments do not need an etching step, and enable a large-area graphene transfer to be performed. The final product made of graphene and polymer may have 2-dimensions (2D) or 3-dimensions (3D). Further, these embodiments may fine tune the graphene-polymeric substrate interactions by the controlling of pressure and heat during the process and the cooling rate. Fine tuning the graphene-polymeric substrate interactions means controlling level of adhesion between the graphene and the polymeric substrate, and also physical, chemical interactions between the polymer and the graphene. The quantity of the area covered by graphene onto substrate is another characteristic that may be controlled by this methodology.

Take the example of the fourth embodiment, when melted polymer is injected into a mold, it is expected that the mold cavities would be filled. However, this is possible if the injection parameters are tuned or optimized such as mass of the polymer injected, injection barrel temperature zones, speed of injection and others. Most of these parameters are correlated with melting viscosity of the polymer. As it can be appreciated from the described embodiments, melting viscosity is one of the rheological properties which need to be considered to perform the graphene transfer. It is also realized that increasing the barrel temperatures at the injection machine would decrease the melting viscosity of the polymeric substrate and all cavities of the mold are filled. However, polymer could be degraded if the temperature is too high. Thus, the transfer temperature needs to be optimized.

In the case of the third embodiment, tubes and others different profiles are fabricated by polymer extrusion. Design of the profiles is obtained by the die of the extruder machine 300. However, the parameters of the extruder machine are dependent on the rheological characteristics of the polymeric substrate. Thus, rheology of the selected polymer for use as the polymeric substrate needs to be considered to produce a final product to minimize defects. It is noted that the rheological properties of polymeric materials may vary with their chemical structures. Therefore, the processing parameters should be reviewed and adjusted when a different polymer is used as a polymeric substrate. A good adhesion between melted polymer and a substrate is obtained with low viscosity of the polymer and good contact. Enough contact time is needed for the graphene molecule to interact or fuse with the polymer molecules and a linkage between them is established (adhesion bond). Temperature of the polymer and applied pressure are parameters to be optimized to form a good adhesion between the melted polymer and the graphene.

The described embodiments may be used to produce final bonded products i.e., target substrate bonded to graphene (in 2D or 3D) for use in a variety of industrial and research sectors including, but not limited to: biomedical applications, composite materials, photovoltaic cells, optical-electronic, electronic devices, as well as research and development.

It should be mentioned that the effectiveness of the described embodiments to transfer graphene to a polymeric substrate is based on melt of the polymer and its contact with graphene (which may or may not be supported by the metal as a growth substrate). A good adhesion between graphene and melted polymer is needed to have a good transfer. The good adhesion is obtained by the use of the control of the temperature and pressure in the polymer processing equipment of the first to fourth embodiments. Therefore, rheological characteristics of the polymer and polymer processing techniques should be understood to achieve a high quality graphene transfer.

With the described embodiments, it is possible to “dry transfer” graphene to a polymeric substrate through complete or partial melting of the polymer by controlling compression pressure and heating using polymer processing techniques. Etching to remove the growth substrate (eg. metal foil) may be avoided and the partial or melted polymer enables a large-area graphene transfer to be performed. The described embodiments allow production of final products made of graphene and polymer with 3 dimensions. In addition, it is also possible to fine tune the graphene-polymeric substrate interaction by controlling of the compression pressure and heat during the process. Fine tuning the graphene-polymeric substrate interactions mean controlling level of adhesion between the graphene and polymeric substrate, and also the chemical and physical interactions between the polymer and the graphene, for example, the doping level of the graphene.

The quantity of the area covered by graphene onto substrate is another characteristic controlled by the described embodiments.

The described embodiments should not be construed as limitative. For example, the general flow in the flowchart 400 of FIG. 4 may be adapted for different applications, as is apparent from the description relating to the first to the fourth embodiments above. Also, in the third embodiment, there may not be opposing rollers in the first and second set of opposing rollers 330,332—a row of rollers should suffice. Also, although FIG. 4 illustrates heating the polymeric substrate at 408, applying the pre-compression pressure at 406 and the compression pressure at 410 as separate steps, any of these could be performed simultaneously. Also, some of the steps illustrated in the flowchart 400 may be omitted.

Although the third embodiment uses solid pieces of polymer and the fourth embodiment uses powdered polymer, other forms of polymer may also be used as a starting point. Instead of LDPE, other polymers may also be used such as, but not limited to, high density polyethylene (HDPE), polystyrene (PS), poly (lactide acid) and poly (vinylidene-fluoride-co-trifluoroethylene) etc.

Although the general term “graphene” is used in the description, it should be clarified that the term “graphene” may include, but not necessarily limited to: graphene monolayer, graphene bilayer, graphene multilayer, graphene foam, graphene oxide, graphene nanoribbons, graphite, graphite oxide, carbon nanotubes, fullerenes and all types of 2D materials.

Also, other methods may be used to grow or produce graphene, not just CVD. For example, Plasma-Enhanced Chemical Vapor Deposition (PECVD), Metal Organic Chemical Vapor Deposition (MOCVD) or sublimation of silicon cabide (SiC). Or graphene may already be grown on growth substrates (not just metals foils) such as Si/SiO₂ and polymer films. Or graphene may have been previously transferred to a substrate such as Si/SiO₂ and polymer films.

Also, the term “polymeric substrate” may include, but not necessarily limited to: homopolymers, copolymers, polymer blends, polymer composites and melted processable elastomers.

The described embodiments provide examples of polymer processing techniques and graphene transfer techniques, but other types of techniques may also be used such as calendaring, blow molding, rotomolding, hot press, thermoforming or combinations of these.

Having now fully described the invention, it should be apparent to one of ordinary skill in the art that many modifications can be made hereto without departing from the scope as claimed.

What is claimed is:

1. A method of transferring graphene to a polymeric substrate, the method comprising:
(i) heating the polymeric substrate to at least partially melt the polymeric substrate;
(ii) compressing the at least partially melted polymeric substrate against the graphene to form an intermediate graphene composite; and
(iii) cooling the intermediate graphene composite to bond the graphene to the polymeric substrate.

2. A method according to claim 1, further comprising:
providing the graphene on at least one of an upper compression member and a lower compression member of a compression machine.

3. A method according to claim 2, wherein the upper compression member includes protruding mold members arranged to cooperate with mold grooves of the lower compression member.

4. A method according to claim 2, further comprising:
applying a pre-compression pressure to enable the graphene to maintain contact with the polymeric substrate for a predetermined time period, and
after the predetermined time period, compressing the at least partially melted polymeric substrate against the graphene includes applying a compression pressure, which is greater than the pre-compression pressure, to the at least partially melted polymeric substrate and the graphene.

5. A method according to claim 4, wherein applying the pre-compression pressure and the heating is performed simultaneously.

6. A method according to claim 2, wherein (iii) includes cooling the intermediate graphene composite at a cooling rate of about 50° C./min until a temperature of about 25° C.

7. A method according to claim 2, wherein the method comprises, prior to (i), growing the graphene directly on the at least one of the upper compression member and the lower compression member.

8. A method according to claim 2, wherein the graphene is grown on a growth substrate, and the method includes, prior to (i), providing the graphene and the growth substrate on the at least one of the upper compression member and the lower compression member.

9. A method according to claim 8, further comprising, after (iii), removing the growth substrate by peeling or electrochemical delamination.

10. A method according to claim 9, further comprising enabling controlling the coverage of the graphene upon peeling by controlling the rheological characteristics of the polymeric substrate.

11. A method according to claim 1, wherein (i) further includes shearing the polymer substrate to produce the at least partially melted polymeric substrate.

12. A method according to claim 11, wherein the shearing is performed by an extruder screw.

13. A method according to claim 11, further comprising:
forcing the at least partially melted polymeric substrate through a die prior to (ii).

14. A method according to claim 11, wherein (ii) includes pressure rolling the at least partially melted polymeric substrate and the graphene through a first set of rollers; and
simultaneously heating the at least partially melted polymeric substrate and the graphene to form the intermediate graphene composite.

15. A method according to claim 14, wherein (iii) includes, after the first set of rollers, pressure rolling the intermediate graphene composite through a second set of rollers, and
simultaneously cooling the intermediate graphene composite to transfer the graphene to the polymeric substrate.

16. A method according to claim 11, wherein the graphene is grown on a growth substrate, and the method further comprises, after (iii), removing the growth substrate by peeling or electrochemical delamination.

17. A method according to claim 11, wherein the shearing is performed by a plunger.

18. A method according to claim 17, wherein (ii) further comprises injecting the at least partially melted polymeric substrate into an injection mold.

19. A method according to claim 18, further comprising, prior to (i), forming graphene on an inner surface of the injection mold.

20. A method according to claim 17, wherein (iii) further comprises opening the mold; and ejecting the transferred graphene and polymeric substrate out of the mold.

21. A method according to claim 20, wherein the graphene is grown on a growth substrate, and the method further comprises, after (iii), removing the growth substrate by peeling or electrochemical delamination.

22. A method according to claim 1, wherein (i) includes heating to a transfer temperature which is at least 10° C. above the polymeric substrate's melting temperature.

23. A method according to claim 1, further comprising, prior to (i), cleaning and drying the graphene and the polymeric substrate.

24. A method according to claim 1, wherein the transferred graphene and polymeric substrate has a 2-dimensional or 3-dimensional structure.

25. A device substrate comprising graphene transferred to a polymeric substrate obtained by the method of claim 1.

26. Apparatus for transferring graphene to a polymeric substrate, the apparatus comprising:
(i) a heater for heating the polymeric substrate to at least partially melt the polymeric substrate;
(ii) a pressure device for compressing the at least partially melted polymeric substrate against the graphene to form an intermediate graphene composite; and
(iii) a cooling device for cooling the intermediate graphene composite to bond the graphene to the polymeric substrate.

27. Apparatus according to claim 26, wherein the pressure device includes an upper compression plate and a lower compression plate opposing the upper compression plate and movable relative to each other, and wherein the graphene is provided on at least one of the upper and lower compression plates.

28. Apparatus according to claim 27, wherein the upper compression member includes protruding mold members arranged to cooperate with mold grooves of the lower compression member.

29. Apparatus according to claim 27, wherein the upper and lower compression members are arranged to apply a pre-compression pressure to enable the graphene to maintain contact with the polymeric substrate for a predetermined time period; and, after the predetermined time period, the upper and the lower compression members are further arranged to apply a compression pressure to the at least partially melted polymeric substrate and the graphene, the compression pressure being greater than the pre-compression pressure.

30. Apparatus according to claim 26, further comprising an extruder screw for shearing the polymer substrate to produce the at least partially melted polymeric substrate.

31. Apparatus according to claim 30, further comprising a die, wherein the extruder screw is arranged to force the at least partially melted polymeric substrate through the die.

32. Apparatus according to claim 31, wherein the pressure device further comprises a first set of rollers downstream of the die, the first set of rollers arranged to pressure roll the at least partially melted polymeric substrate and the graphene, and a roller heater for simultaneously heating the at least partially melted polymeric substrate and the graphene to form the intermediate graphene composite.

33. Apparatus according to claim 32, wherein the cooling device is coupled to a second set of rollers downstream of the first set of rollers, the second set of rollers arranged to pressure roll the intermediate graphene composite, and the cooling device arranged to simultaneously cool the intermediate graphene composite to transfer the graphene to the polymeric substrate.

34. Apparatus according to claim 26, further comprising a plunger for shearing the polymer substrate to produce the at least partially melted polymeric substrate.

35. Apparatus according to claim 34, further comprising an injection mold, wherein the plunger is arranged to inject the at least partially polymeric substrate into the injection mold.

36. Apparatus according to claim 35, wherein the injection mold includes extractors for ejecting the transferred graphene and the polymeric substrate out of the injection mold.

37. Apparatus according to claim 35, wherein the cooling device is coupled to the injection mold and arranged to cool the intermediate graphene composite to transfer the graphene to the polymeric substrate.

38. A method of transferring graphene to a polymer substrate, the method comprising,
i) cleaning and drying the graphene and polymeric substrate;
ii) positioning the graphene and the polymeric substrate into desired structure;
iii) adjusting temperature of plates;
iv) positioning the desired structure between the plates; and
v) applying pressure to the desired structure via the plates, thereby allowing the polymeric structure to become fluid or melted to allow the graphene to be transferred onto the substrate.
